(19) United States
(12) Patent Application Publication
(10) Pub. No.: US 2004/0204155 A1
(43) Pub. Date: Oct. 14, 2004

(54) Non-rechargeable wireless headset

(76) Inventor: Shary Nassimi, Ridgefield, WA (US)

Correspondence Address: Craig W. Barber, P.O. Box 16220, Golden, CO, 80402-6004, US

(21) Appl. No.: 10/152,706

(22) Filed: May 21, 2002

(51) Int. Cl. H04B 1/38

(52) U.S. Cl. 455/569.1; 455/574; 455/575.1

(57) ABSTRACT

The present invention teaches a non-rechargeable hands free headset of small size. With the headset is a base transceiver unit which connects to the cell phone or other device having audio input and output. The headset transceiver unit may use a small non-rechargeable battery (“coin size”) for reduced size and easy recharging. The base transceiver unit may communicate with the headset via half or full duplex transmission and reception. This may also be achieved in alternative embodiments by digitally encoding one or both of the signals and transmitting them as digital data. The antenna of the headset unit may be located on or within the microphone tube, thus allowing a reduced headset size. Another space, weight and cost saving feature of the present invention is the ability to automatically control volume. Automatic volume control allows elimination of external volume control structure yet still allows volume control to occur. In the present invention, volume is controlled by the base device attached to the base transceiver unit. By this means, battery life may be extended yet without the cost and bulk of an external control device such as a switch of a size suitable for a user's fingers to operate.

### FIELD OF THE INVENTION

This invention relates to generally to wireless headsets and specifically to “hands free” full duplex wireless headsets for cell phones and other devices with audio input and output.

### BACKGROUND OF THE INVENTION

Cellular telephones, while convenient, require the user to use one hand to hold the telephone in proximity to ear and mouth in order to use the telephone. In addition, when the user wishes to use a cell phone control such as the alphanumeric keypad, the user must take the cell phone from their ear and transfer it to a location in which they can see the keypad and push 20 buttons as needed. In addition to inconvenience and distraction from contraindicated activities such as driving, this is a two handed process. These problems are not restricted to cellular telephones as a growing number of types of devices offer users audio input and output data. Personal computers and personal digital assistants, as two examples, offer increasingly efficient speech recognition. Digital and tape recorders, which do not offer voice recognition, are also examples of the types of devices which may increasingly be voice activated and may even offer preprogrammed voice output.

The requirement of holding a device such as a cell telephone to the ear in turn causes various other problems, safe operation of motor vehicles being one major example of such issues, tiredness by the user's arm being a less important type of problem. For these reasons and others, vendors and inventors are offering a range of solutions to the problem of “hands free” cell phone operation.

One attempt to solve this problem is the “hands free cell phone” in which the volume of the audio output and the sensitivity of the audio input are dramatically increased. The user places the cell phone or other device in a special holder or merely places it on seat or dashboard and speaks loudly. Such systems have numerous disadvantages: audio feedback, ambient interference and poor sound quality, among others. Lack of privacy is increasingly an issue as well, since both sides of the conversation are clearly audible to anyone nearby.

One more promising route for improvement is the use of the headset. By wearing earphones and a microphone, a user can escape the need to continuously hold the cellular telephone or other audio input/output device. Unfortunately, headset cords connecting the headset to the base device can entangle the user's hands, arms, or whatever they may be using, such as a computer keyboard or steering wheel, thus posing a threat on their own. The solution to this problem is the wireless headset, in which the headset device and base device communicate by means of RF transmissions.

Wireless headsets offer a potentially life saving hands free mode of operation for motor vehicles and other activities which require continuous active use of two hands. The user wears the wireless headset with microphone and speakers, leaves the base unit safely tucked away, and is in no danger of having one or more hands entangled in a cord or used to control the base device. This life saving ability is of increasing importance as the number of cell telephones on the road proliferates and drivers increasingly ignore safety (and in some jurisdictions the law) in order to use their telephone, computer, recorder or other device. Other situations than driving may also show the life saving features of the present invention: skiing, bicycling, operation of industrial machinery, printing presses, civil engineering equipment, etc.

And in yet a broader range of applications, the device of the present invention may be used to provide convenience and increase productivity: secretarial work, telemarketing, office work, etc.

Various wireless headsets schemes have been proposed. In general, the problem with most headsets is size, bulk, and lack of ease of use. The following prior art head sets show these disadvantages.

U.S. Pat. No. 4,882,745 issued Nov. 21, 1989 to Silver for “CORDLESS HEADSET TELEPHONE” shows one early telephone headset in the context of a conventional land-line telephone. The headset disclosed has a large ear piece, telescoping antennas in both base unit and headset, and a cross section so large as to include a keypad on the headset portion of the device. The '745 patent teaches only that charging of the headset battery is accomplished by means of contacts 29 seen in FIG. 2 and FIG. 5. The headset also includes on/off switches and a manual volume control.

U.S. Pat. No. 5,590,417 issued Dec. 31, 1996 to Rydbeck for “RADIOTELEPHONE APPARATUS INCLUDING A WIRELESS HEADSET” teaches a headset in which recharging is accomplished when the headset is attached to the base transceiver unit. The gain control of the headset is accomplished manually by means of controls in the base transceiver unit, as discussed in column 4 at lines 38 through 59. Two embodiments are taught in both of which manual control of headset output volume is accomplished manually at the base transceiver unit.

U.S. Pat. No. 6,078,825 issued Jun. 20, 2000 to Hahn et al. for “MODULAR WIRELESS HEADSET SYSTEM FOR HANDS FREE TALKING” and U.S. Pat. No. 6,230,029 B1 issued May 8, 2001 to Hahn et al. for “MODULAR WIRELESS HEADSET 1 SYSTEM” disclose a headset having battery contacts used to charge the removable battery pack module. These patents also teach that the headset have manual on/off, channel and volume controls.

Finally, US Patent Application Publication No. US 2001/0016506 A1 published Aug. 23, 2001 in the name of Son et al. and entitled “WIRELESS HANDS-FREE SYSTEM OF CELLULAR PHONE” teaches a battery operated hands free headset having a battery saving feature described in paragraph 0014. No indication of any means of charging of the battery is present in the publication, and as specified in the final phrase of paragraph 0013, a switch on the headset is operated by the user.

The size and weight of these headset devices is increased by the use of various ancillary 20 devices such as on/off switches, volume controls, etc, the functions of these device can be better handled by means of different and smaller structures. In addition, the charging schemes proposed by these inventions require larger sizes and additional structure for the headset. Presumably, changing of batteries in the prior art devices (not disclosed in any device) requires partial disassembly of the head set units. This is acceptable in the context of a rechargeable battery requiring only occasional battery changes, albeit at the price of having charging equipment in the headset which adds to weight and complexity. The present invention, however, eliminates the need for recharging equipment.

The companion application mailed on May 9^{th}, 2002, by the same inventor and entitled “Improved Wireless Headset” (filing receipt not yet received) is another example of a rechargeable device. In that application, recharging is accomplished by means of magnetic induction of current.

### SUMMARY OF THE INVENTION

General Summary

The present invention teaches a hands free headset of small size which is more easily used than previous designs, having a non-rechargeable batter.

With the headset is a base transceiver unit which connects to the cell phone or other device having audio input and output. The base transceiver unit may be attached to a cell phone by a variety of structures such as a 2.5 mm jack; such jacks already exist on various types of cellular telephones. The headset transceiver unit may use a small non-rechargeable battery 20 (“coin size”) for reduced size and easy recharging. Various types of non-rechargeable batteries may be used (Zinc-Air, Lithium, Alkaline, etc) in the present invention. The base transceiver unit communicates with the headset via half or full duplex transmission and reception, allowing continuous audio input and output as needed. This may also be achieved in alternative embodiments by digitally encoding one or both of the signals and transmitting them as digital data.

Advantageously, high frequencies may be utilized by the invention in order to provide greater antenna efficiency and clarity of sound. The antenna of the headset unit may be located on or within the microphone tube, thus allowing a reduced headset size.

Another space, weight and cost saving feature of the present invention is the ability to automatically control volume. Automatic volume control allows elimination of external volume control structure yet still allows volume control to occur. In the present invention, volume is controlled by the base device attached to the base transceiver unit.

Summary in Reference to Claims

It is one aspect, advantage, objective and embodiment of the present invention to provide a wireless headset comprising: a clip dimensioned and configured to hold the wireless headset properly oriented near the ear and mouth of a user; a microphone operatively connected to a radio frequency transmitter; a speaker operatively connected to a radio frequency receiver; and at least one battery, the battery being non-rechargeable.

It is another aspect, advantage, objective and embodiment of the present invention to provide a wireless headset further comprising: a power control device capable of controlling current flow to at least one member of the group comprising: the transmitter, the receiver, the speaker, the microphone, and combinations thereof, wherein; the power control device has no manual control.

It is another aspect, advantage, objective and embodiment of the present invention to provide a wireless headset further comprising: a body portion within which the transmitter and receiver are contained.

It is another aspect, advantage, objective and embodiment of the present invention to provide a wireless headset wherein the transmitter uses a radio frequency in the range from 100 MHz to 2.4 GHZ.

It is another aspect, advantage, objective and embodiment of the present invention to provide a wireless headset further comprising an antenna, and a microphone tube, wherein the microphone is contained within the microphone tube.

It is another aspect, advantage, objective and embodiment of the present invention to provide a wireless headset wherein the at least one non-rechargeable battery further comprises a battery selected from the group comprising: zinc-air batteries, lithium batteries, alkaline batteries, oxide batteries, silver oxide batteries, mercuric oxide batteries, and combinations thereof.

It is another aspect, advantage, objective and embodiment of the present invention to provide a wireless headset wherein the at least one non-rechargeable battery further comprises a zinc-air battery.

It is another aspect, advantage, objective and embodiment of the present invention to provide a wireless headset comprising: a clip dimensioned and configured to hold the wireless headset properly oriented near the ear and mouth of a user; a microphone operatively connected to a radio frequency transmitter; a speaker operatively connected to a radio frequency receiver; at least one non-rechargeable battery; at least one antenna operatively connected to one member selected from the group comprising: the transmitter, the receiver, both the transmitter and receiver; a microphone tube having first and second ends, the microphone tube dimensioned and configured such that when the wireless headset is properly oriented near the ear and mouth of the user, the first end of the microphone tube is located near the mouth of the user; wherein the at least one antenna runs along the microphone tube.

It is another aspect, advantage, objective and embodiment of the present invention to provide a wireless headset further comprising: a power control device capable of controlling current flow to at least one member of the group comprising: the transmitter, the receiver, the speaker, the microphone, and combinations thereof, wherein; the power control device has no manual control.

It is another aspect, advantage, objective and embodiment of the present invention to provide a wireless headset further comprising: a body portion within which the transmitter and receiver are contained.

It is another aspect, advantage, objective and embodiment of the present invention to provide a wireless headset wherein the transmitter uses a radio frequency in the range from 100 MHz to 2.4 GHz.

It is another aspect, advantage, objective and embodiment of the present invention to provide a wireless headset wherein the at least one non-rechargeable battery further comprises a battery selected from the group comprising: zinc-air batteries, lithium batteries, alkaline batteries, oxide batteries, silver oxide batteries, mercuric oxide batteries, and combinations thereof.

It is another aspect, advantage, objective and embodiment of the present invention to provide a wireless headset wherein the at least one non-rechargeable battery further comprises a zinc-air battery.

### BRIEF DESCRIPTION OF THE DRAWINGS

FIG. 1 is a side view of the first embodiment of the improved wireless headset of the invention.

FIG. 2 is a block diagram of a second embodiment of the invention, showing the overall system in use with a cell phone.

### DETAILED DESCRIPTION

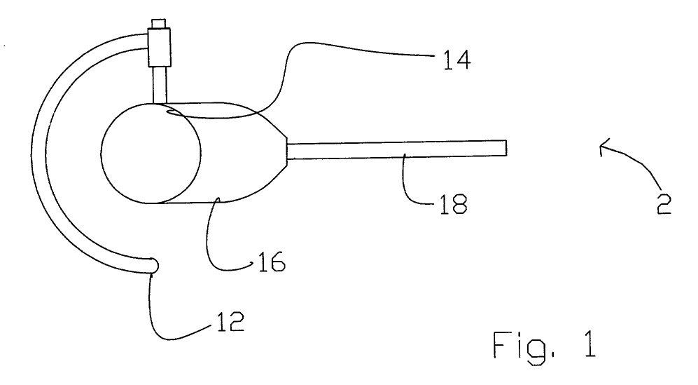

FIG. 1 is a side view of the first embodiment of the improved wireless headset of the invention. Headset 2 has ear clip 12 used to retain headset 2 on an ear. Earpiece speaker 14 fits in or over the user's ear. Body 16 contains the electronic devices used to make the headset device work properly, while microphone tube 18 may contain a microphone (not shown). The microphone may be located at the base of microphone tube 18 inside or near to body 16, or in alternative embodiments the microphone may be located at other locations in or on microphone tube 18. While clip 12 is the preferred embodiment and best mode presently contemplated for holding the headset to the user's ear and properly oriented near the user's ear and mouth, other structure such as elastic bands, hair clips, head bands, etc, may be substituted without departing from the scope of the invention. Microphone tube 18 has two ends, one located at body 16, the other located such that when the headset is worn properly, one end of microphone tube 18 is located near the user's mouth.

Microphone tube 18 may also advantageously contain one or more antennae. This allows increased length for each antenna and yet does not increase the overall length of headset 2.

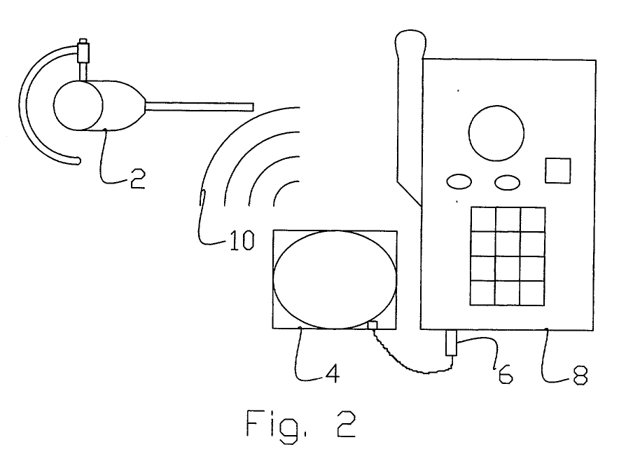

FIG. 2 is a block diagram of a second embodiment of the invention, showing the overall system in use with a cell phone. Headset 2 communicates via 2-way RF link with base transceiver 4. Base transceiver 4 in turn has connections 6 to base unit 8. In the second embodiment, base unit 8 may be a cell phone (as shown in FIG. 2) or may be another type of device. Such devices now include computers (which are increasingly able to input, process, and output, human speech), personal digital assistants, recorders, other consumer electronic devices, and in the future, a wide range of other devices which are not presently known (real-time verbal translators) or which are presently known but which are not presently susceptible to reliable audio input and output (automobiles for handicapped mobility). Such devices, now known or later developed, are included within the possible types of base units useful with the present invention.

The base transceiver unit container various electronic circuitry and devices necessary for proper operation of the unit. The base unit connects via a connection to a base transceiver unit. The base unit may be any of the devices as discussed previously. The connection may be a cable and 2.5 mm jack, another form of standard jack such as is used in the telecommunication industry (for example, RJ-11), or another form of standard jack such as is used in the computer industry (IEEE 1394, USB, etc) or another type of jack. The connection may also be made without a cable/jack structure, for example, the base transceiver unit may be integrated into the base unit, or a non-physical connection may be established, etc. An interface performs matching of impedance (resistance), protocols, and/or physical matching to the connection means, then sends the signals to be sent to a headset unit to a preamp. After the signal is boosted, filtered, transformed and otherwise handled in the preamp, the transmitter sends an RF signal. An antenna may advantageously be used with the transmitter. The transmitter may use any frequency legally available, for example, in the US, the Federal Communications Commission establishes and regulates use of such frequencies. RF signals may advantageously be a high frequency signal allowing greater bandwidth and thus an increased audio data capacity and greater clarity, broader audio frequency range transmission, etc. RF signals may be full or half duplex, or may be digitally encoded by any method (TDMP, etc).

The receiver sends RF data in the other direction, receiving it from the headset transceiver unit and sending it to the base unit. In the embodiment shown, the receiver sends the RF data to the connection, however, the receiver may in other alternative embodiments operate through other circuitry such as the interface or analogous devices.

Receiver and transmitter may operate independently, may operate in full-duplex mode, etc, thus allowing simultaneous transmission and reception.

External power may be a conventional AC power source at the locally used voltage and frequency (for example 115 VAC @ 60 Hz), or it may be a DC power source (such as 12 volt or 42 volt supplies found in vehicles). External power may be omitted and the base may operate on battery power alone. External power goes to a power supply for any necessary inversion to AC, conversion to DC, etc. For example, in an alternative embodiment in which the circuitry of the base transceiver unit operates at 5 volts DC, the power supply may convert from 240 VAC to 5 VDC.

The unit's battery may provide power to both a power supply and power control circuitry.

Power control circuitry assists in saving energy by controlling the power flow to transmitter, receiver, power supply, and other associated circuitry. Power control circuitry thus saves energy and furthermore increases battery life. Power control circuitry may operate automatically to turn on and off the transmitter or the power supply, and may operate to turn on and off or to mute the receiver.

Details of the headset are as follows: the headset has preamp, microphone, transmitter, earpiece speaker, receiver and one or more antennae. These function in a manner analogous to that described above in reference to the base transceiver unit. The microphone picks up audio signals from the user, converts such audio data to electronic information and transmitter sends the signals to base transceiver unit as radio frequency emissions. The receiver picks up RF emissions from the base transceiver unit and sends them to the earpiece speaker for conversion to audible format (sound waves) for the user. In the presently preferred embodiment and best mode presently contemplated for carrying out the invention, antennae may be hidden within microphone tube 18 (see FIG. 1). By this method the overall size of the headset may be kept small. Antennae may also be located on microphone tube 18. In any case, antennae may run along a portion or all of the length of microphone tube 18.

Size, weight and cost being important issues in headset design, it is desirable to eliminate as much structure as possible without eliminating the associated functionality. In the headset, the power supply is powered by a non-rechargeable battery without need for physical connection to any external power source. This is enabled by the fact that the battery is non-rechargeable. Thus, it is possible for the headset of the present invention to do away entirely with recharging plugs, sockets, contacts, and other physical structure/devices for contact or inductive recharging, thus saving weight, space and cost. In addition, users are not required to “plug into” a special charging stand. When the battery or batteries are low, they may simply be changed.

In order to provide the most efficient battery life possible, and to further reduce weight, size and cost, power control circuitry is also provided in the headset. Power control circuitry eliminates the need for a headset mounted volume control, a headset mounted on/off switch and other devices.

During use, power control circuitry and/or the receiver may act to automatically control volume of the audio output from the earpiece speaker. Power control circuitry and/or the transmitter may also act to control transmission strength to the base transceiver unit. By means of this structure, battery life and sound quality may be enhanced, but without the cost and bulk of an external control device such as a knob large enough for manipulation by a user's fingers.

When the user desires manual volume control, the user may accomplish this by adjusting the volume of the base device (such as a cell phone) to which the base transceiver is attached.

Furthermore, power control circuitry may turn on and off the receiver and the transmitter in a manner similar to that described above in reference to base the transceiver unit. By this means, battery life may be extended yet without the cost and bulk of an external control device such as a switch of a size suitable for a user's fingers to operate.

Power control of the headset may act independently of the base unit power control or may cooperate with the base unit power control/circuitry. For example, the headset power control may act to shut down headset transmitter whenever a user silence is detected, or the power control circuitry may receive a signal from the base unit informing it of the end of a transmission or of the end of a user session such as a single telephone call.

The non-rechargeable battery is important to the present invention in that it allows the invention to do without recharging apparatus such as contacts, jacks, induction coils and so on. There are several types of non-rechargeable batteries which may be used, such as traditional lithium or alkaline batteries, silver oxide, mercuric oxide, etc, or the newer zinc-air battery.

The zinc-air battery uses a zinc anode of gelled zinc powder and catalyzed carbon cathodes. It is sealed until use, then opened when it is installed. The zinc is oxidized while air enters the cathode. The net chemical reaction is that zinc is oxidized, oxygen reduced, and an average of 1.4 volts is generated. The battery has very advantageous characteristics in terms of discharge curve (relatively constant output) and capacity (better than traditional cells).

This disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. An wireless headset comprising:
a clip dimensioned and configured to hold the wireless headset properly oriented near the ear and mouth of a user;
a microphone operatively connected to a radio frequency transmitter;
a speaker operatively connected to a radio frequency receiver; and
at least one battery, the battery being non-rechargeable.

2. The wireless headset of claim 1, further comprising:
a power control device capable of controlling current flow to at least one member of the group comprising: the transmitter, the receiver, the speaker, the microphone, and combinations thereof, wherein;
the power control device has no manual control.

3. The wireless headset of claim 1, further comprising:
a body portion within which the transmitter and receiver are contained.

4. The wireless headset of claim 1, wherein the transmitter uses a radio frequency in the range from 100 MHz to 2.4 GHZ.

5. The wireless headset of claim 5, further comprising
an antenna,
a microphone tube, wherein the microphone is contained within the microphone tube.

6. The wireless headset of claim 1, wherein the at least one non-rechargeable battery further comprises a battery selected from the group comprising: zinc-air batteries, 5 lithium batteries, alkaline batteries, oxide batteries, silver oxide batteries, mercuric oxide batteries, and combinations thereof.

7. The wireless headset of claim 1, wherein the at least one non-rechargeable battery further comprises a zinc-air battery.

8. A wireless headset comprising:
a clip dimensioned and configured to hold the wireless headset properly oriented near the ear and mouth of a user;
a microphone operatively connected to a radio frequency transmitter;
a speaker operatively connected to a radio frequency receiver;
at least one non-rechargeable battery;
at least one antenna operatively connected to one member selected from the group comprising: the transmitter, the receiver, both the transmitter and receiver;
a microphone tube having first and second ends, the microphone tube dimensioned 20 and configured such that when the wireless headset is properly oriented near the ear and mouth of the user, the first end of the microphone tube is located near the mouth of the user;
wherein the at least one antenna runs along the microphone tube.

9. The wireless headset of claim 8, further comprising:
a power control device capable of controlling current flow to at least one member of the group comprising: the transmitter, the receiver, the speaker, the microphone, and combinations thereof, wherein;
the power control device has no manual control.

10. The wireless headset of claim 8, further comprising:
a body portion within which the transmitter and receiver are contained.

11. The wireless headset of claim 8, wherein the transmitter uses a radio frequency in the range from 100 MHz to 2.4 GHz.

12. The wireless headset of claim 8, wherein the at least one non-rechargeable battery further comprises a battery selected from the group comprising: zinc-air batteries, lithium batteries, alkaline batteries, oxide batteries, silver oxide batteries, mercuric oxide batteries, and combinations thereof.

13. The wireless headset of claim 8, wherein the at least one non-rechargeable battery further comprises a zinc-air battery.
